(19) United States
(12) Patent Application Publication
(10) Pub. No.: US 2024/0362676 A1
(43) Pub. Date: Oct. 31, 2024

(54) METHOD AND SYSTEM FOR OPTIMIZATION OF CAMPAIGN DELIVERY TO IDENTIFIED USER GROUPS

(71) Applicant: Target Brands, Inc., Minneapolis, MN (US)

(72) Inventors: GAURAV BANGAD, Bengaluru (IN); SUGUNA MEKALA, Bengaluru (IN); SASANK CHANNAPRAGADA, Bengaluru (IN); ARPITH PRAKASH, Bengaluru (IN); YASH CHODAVARAPU, Bengaluru (IN); MUDIT RANJAN PATI, Bengaluru (IN)

(21) Appl. No.: 18/138,855

(22) Filed: Apr. 25, 2023

(51) Int. Cl. G06Q 30/0251; G06Q 30/0241; G06Q 30/0242

(52) U.S. Cl. CPC G06Q 30/0254; G06Q 30/0244; G06Q 30/0249

(57) ABSTRACT

Methods and systems for optimizing campaign delivery of messages, such as offers or incentives, are provided. A set of statistical and learning models identify similar campaigns, and generate recommendations for the current campaign based on past performance as measured by engagement with and performance of identified previous campaigns. An optimization tool may be used in conjunction with an offer distribution platform that identifies individual user groups, and develops recommended offers to be included within the campaign for use with specific users or user groups to achieve optimized results within provided campaign objectives.

### BACKGROUND

Large enterprises, in particular retail enterprises, often has a set of target customers to whom they wish to provide communications or incentives to interact. For example, a large scale retail enterprise may wish to communicate with past customers or prospective customers via email, direct mail, text message, or in application message, regarding specific product messaging or incentives that may be of interest to those customers.

A primary concern regarding such messaging is identifying the specific individuals to whom communications are of most interest. Delivering communications of lesser interest to particular customers may result in wasted costs (e.g., in particular in the case of the direct mailing) or wasted effort, and overall results in a less efficient offer or incentive program. Additionally, including too many individuals or customers within a given incentive program may result in sending a day luge of communications to any given individual, increasing the likelihood that the individual will disregard a particular incentive or communication. As such, inefficient messaging to customers results in wasted efforts, wasted costs, and lower consumer engagement.

### SUMMARY

In general, this disclosure relates to a platform for optimizing campaign delivery of messages, such as offers or incentives, to identify user groups. In particular, the present application uses a set of statistical and learning models to identify past performance as measured by customer engagement with previous campaigns. An optimization tool may be used in conjunction with an offer distribution platform that identifies individual user groups and campaigns.

In one aspect, a method of optimizing an information distribution campaign for delivery to an audience is provided. The method includes receiving, at a campaign definition user interface of a campaign distribution platform, a campaign definition of a current campaign including a plurality of campaign parameters, the plurality of campaign parameters including an audience type, a campaign objective, a duration of the campaign, a budget, a set of customer selection criteria. The method also includes intaking the campaign definition at an intake service module and storing the campaign definition in a database table, as well as automatically executing a lookalike process to identify historical campaigns having a greatest similarity to the campaign definition, the lookalike process generating a similarity score for each of a plurality of the historical campaigns. The method includes determining one or more offers to be included in the campaign based, at least in part, on performance of the historical campaigns having the greatest similarity to the campaign definition, the one or more offers including at least one percentage offer or at least one threshold offer, and generating, at a model trained using historical customer and campaign data, a redemption score representative of a likelihood of a customer redeeming each of the one or more offers, the redemption score being generated by the model for each of a plurality of customer-offer groups across a plurality of customers. The method includes allocating to a campaign a mapped list of customer-offer groups from among the plurality of customer-offer groups based on at least one of the redemption scores or a predicted basket size of each customer in the customer-offer groups, generating a test list and a control list of customers from among the customer-offer groups, and publishing the current campaign to a campaign API managed by the campaign distribution platform.

In a further aspect, a campaign definition and optimization system for is provided. The system includes a campaign distribution platform operable on a computing system, the campaign distribution platform exposing a campaign definition user interface and a campaign API, as well as a campaign optimization tool executable on a second computing system. The campaign optimization tool is executable by a processor of the second computing system to perform: receiving, from the campaign distribution platform via the campaign API, a campaign definition of a current campaign including a plurality of campaign parameters, the plurality of campaign parameters including an audience type, a campaign objective, a duration of the campaign, a budget, a set of customer selection criteria; intaking the campaign definition at an intake service module and storing the campaign definition in a database table; and automatically executing a lookalike process to identify historical campaigns having a greatest similarity to the campaign definition, the lookalike process generating a similarity score for each of a plurality of the historical campaigns. The campaign optimization tool is further executable to perform determining one or more offers to be included in the campaign based, at least in part, on performance of the historical campaigns having the greatest similarity to the campaign definition, the one or more offers including at least one percentage offer or at least one threshold offer, and generating, at a model trained using historical customer and campaign data, a redemption score representative of a likelihood of a customer redeeming each of the one or more offers, the redemption score being generated by the model for each of a plurality of customer-offer groups across a plurality of customers. The campaign optimization tool is also executable to perform allocating to a campaign a mapped list of customer-offer groups from among the plurality of customer-offer groups based on at least one of the redemption scores or a predicted basket size of each customer in the customer-offer groups, generating a test list and a control list of customers from among the customer-offer groups, and publishing the current campaign to the campaign API managed by the campaign distribution platform.

In a further aspect, a non-transitory computer-readable storage medium comprising computer-executable instructions is disclosed. The instructions, when executed by a processing device of a computing system, cause the computing system to perform a method of optimizing an information distribution campaign for delivery to an audience. The method includes receiving, at a campaign definition user interface of a campaign distribution platform, a campaign definition of a current campaign including a plurality of campaign parameters, the plurality of campaign parameters including an audience type, a campaign objective, a duration of the campaign, a budget, a set of customer selection criteria. The method also includes intaking the campaign definition at an intake service module and storing the campaign definition in a database table, as well as automatically executing a lookalike process to identify historical campaigns having a greatest similarity to the campaign definition, the lookalike process generating a similarity score for each of a plurality of the historical campaigns. The method includes determining one or more offers to be included in the campaign based, at least in part, on performance of the historical campaigns having the greatest similarity to the campaign definition, the one or more offers including at least one percentage offer or at least one threshold offer, and generating, at a model trained using historical customer and campaign data, a redemption score that is representative of a likelihood of a customer redeeming each of the one or more offers. The redemption score is generated by the model for each of a plurality of customer-offer groups across a plurality of customers. The method includes allocating to a campaign a mapped list of customer-offer groups from among the plurality of customer-offer groups based on at least one of the redemption scores or a predicted basket size of each customer in the customer-offer groups, generating a test list and a control list of customers from among the customer-offer groups, and publishing the current campaign to a campaign API managed by the campaign distribution platform.

Other objects and advantages of the invention will be apparent to one of ordinary skill in the art upon reviewing the detailed description of the invention.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 is a schematic diagram illustrating a retail network in which a campaign for communicating with customers and potential customers may be implemented.

FIG. 2 is a schematic process flow diagram for implementing a campaign, according to an example embodiment.

FIG. 3 is a schematic block diagram of an architecture of a campaign delivery system, usable within the retail network of FIG. 1 to implement a campaign.

FIG. 4 is a schematic block diagram of an architecture of a campaign optimization tool usable within the campaign delivery system of FIG. 3.

FIG. 5 is a schematic diagram of use of a plurality of predictive models within the campaign optimization tool of FIG. 4.

FIG. 6 is an example data set usable to generate recommended campaigns using the campaign optimization tool described herein.

FIG. 7 is a schematic diagram of a campaign management user interface implemented using a campaign distribution platform.

FIG. 8 is a schematic diagram of a further campaign management user interface usable in conjunction with the user interface of FIG. 7.

FIG. 9 is a schematic diagram of a campaign performance user interface illustrating redemption results in an example application of a campaign according to an example embodiment.

FIG. 10 is a schematic diagram of a further campaign performance user interface illustrating redemption results in an example application of a campaign according to an example embodiment.

FIG. 11 is a flowchart of an example method of generating a campaign using the campaign delivery system and campaign optimization tool as described herein.

FIG. 12 is a schematic block diagram of a computing device with which aspects of the present disclosure may be implemented.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

For purposes of this patent document, the terms “or” and “and” shall mean “and/or” unless stated otherwise or clearly intended otherwise by the context of their use. Whenever appropriate, terms used in the singular also will include the plural and vice versa. The use of “a” herein means “one or more” unless stated otherwise or where the use of “one or more” is clearly inappropriate. The use of “or” means “and/or” unless stated otherwise. The use of “comprise,” “comprises,” “comprising,” “include,” “includes,” “including,” “having,” and “has” are interchangeable and not intended to be limiting. The term “such as” also is not intended to be limiting. For example, the term “including” shall mean “including, but not limited to.”

All ranges provided herein include the upper and lower values of the range unless explicitly noted. Although values are disclosed herein when disclosing certain exemplary embodiments, other embodiments within the scope of the pending claims can have values other than the specific values disclosed herein or values that are outside the ranges disclosed herein.

Terms such as “substantially” or “about” when used with values or structural elements provide a tolerance that is ordinarily found during testing and production due to variations and inexact tolerances in factor such as material and equipment.

Generally speaking, the present disclosure relates to systems and methods for optimizing campaign delivery of messages, such as offers or incentives, to identify user groups. In particular, the present application uses a set of statistical and learning models to identify past performance as measured by customer engagement with previous campaigns. An optimization tool may be used in conjunction with an offer distribution platform that identifies individual user groups and campaigns. Optimized campaigns may include, for example, an optimized set of offer depths to be delivered to modeled user groups to obtain an optimal performance of the campaign overall. Stated differently, the present disclosure determines, based on business constraints, appropriate offer depths to be delivered to modeled user groups to obtain optimized campaign performance.

In the example implementations, the optimization provided herein may be particularly adapted to campaigns that include physical communication media being created and sent to customers and potential customers, such as in the case of direct mail campaigns. Campaigns may include digital delivery methods as well. In any such instances, a model driven approach may be used to maximize redemption by individuals. Maximization of a redemption probability may be performed, or maximization of incremental sales may be analyzed and optimized for. Because a potential customer may, on average, take a redemption “trip” to a physical store or to visit an online retailer and may purchase more items than only the item that is subject of the campaign, it can be difficult to identify an appropriate audience for a given campaign. By better identifying likely redeemers of campaign offers, significant improvements in the overall campaign process may be achieved through reduced unredeemed deliveries, increased redemption rates, and optimization of a potential incentive budget associated with the campaign (e.g., a markdown budget) by ensuring that the campaign is delivered to those individuals who are most likely to not only redeem the campaign offer, but do so in the context of a significant purchase of offered and potentially non-offered items from the retailer.

In some examples, the predictive models used to identify an appropriate audience for a campaign may further generate a set of key factors that contribute to redemption by that particular audience. Such a set of key factors may be provided to a designer of the campaign, thereby allowing that desire to better understand customer behavior and tendencies. Additional user interfaces depicting campaign performance may be presented as well.

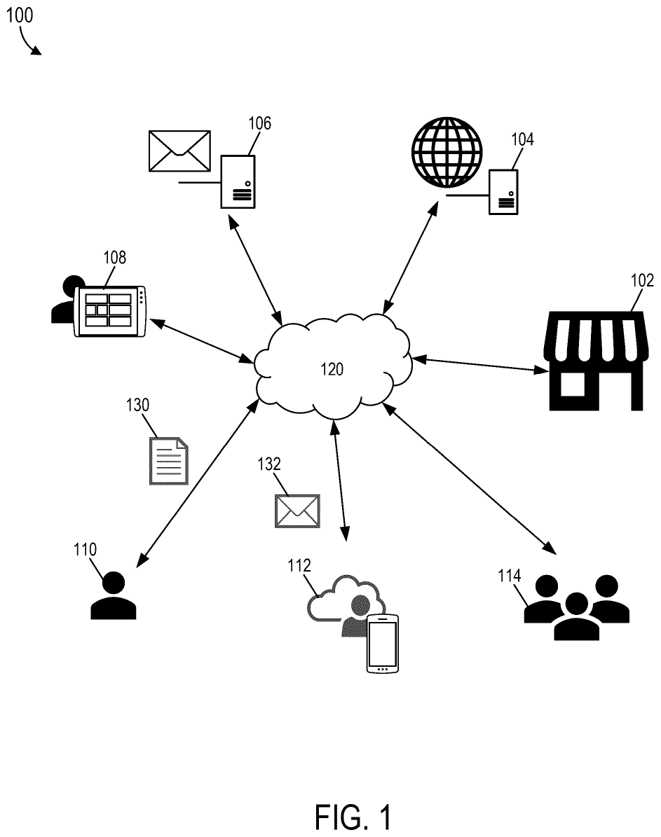

Referring first to FIG. 1, a schematic diagram illustrating a retail network 100 in which a campaign for communicating with customers and potential customers may be implemented. In the example shown, the retail network 100 includes one or more retail locations 102, a retail website 104, and a campaign delivery system 106.

In examples, the one or more retail locations 102 offer items for sale. The items for sale may be organized in a variety of ways. For example, items for sale may include all items storewide at a given retail location, or may be organized into a plurality of different departments, or classes. In some instances, the retail organization managing the retail locations 102 may opt to conduct a campaign to promote sales within a given department, a given class, or for a particular item. In some instances, different ones of the retail locations 102 may offer different collections of items for sale.

In examples, the retail website 104 also offers items for sale to customers. As with the retail locations 102, the retail website 104 may be organized into various departments, and items may be subject to campaigns at the item level, category level, or department level.

As illustrated, the campaign delivery system 106 may be used to define and implement one or more campaigns, such as promotional campaigns. A promotional campaign may include a communication regarding a particular item or class of items, and may take the form of a direct mail message to end users, or may be sent via email, SMS message, push message to a mobile application, or the like. In examples, the campaign delivery system 106 may be implemented using a plurality of computing systems, as described further detail below.

In some examples, the retail network 100 further includes an administrative user device 108, usable by an administrative user such as an employee of the retailer. The administrative user device 108 may be used to display one or more user interfaces able to define, review, and track performance of campaigns as described further below.

As illustrated in FIG. 1, the retail network 100 may be configured to communicate with a variety of users, such as users 110, 112, 114. Each of the users may also be referred to as customers, which encompasses both past customers and prospective customers. In the example shown, communication with user 110 may be by direct mail message 130. Communication with user 112 may be by SMS message 132 or by push message to a mobile application. Users 110, 112 may be selected to receive such messages from among a larger group of users 114, which may encompass all past customers or prospective customers of the retail enterprise.

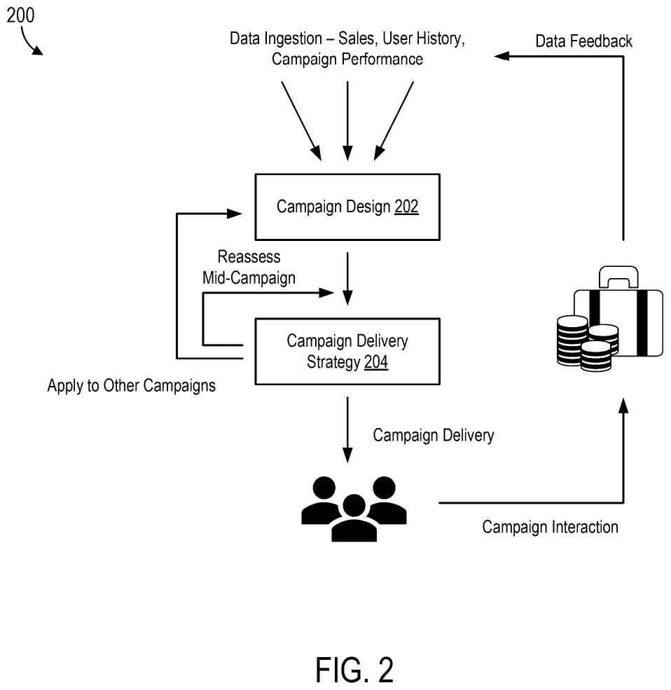

FIG. 2 is a schematic process flow diagram 200 for implementing a campaign, according to an example embodiment. In the example shown, a given campaign may be created by use of a campaign design system 202, which may ingest data from a variety of locations or sources within a retail enterprise. For example, past sales, user data including user purchase histories, and past campaign performance may be used in designing a campaign. Additionally, a campaign delivery strategy subsystem 204 may be used, for example after initiation of a campaign. The campaign delivery strategy subsystem 204 may be used to reassess a campaign during its duration, and may provide feedback to the campaign design subsystem 202 that may be used in application to other campaigns, for example during the duration of an existing campaign. Additionally, campaign interactions with a given audience for the campaign may take the form of purchases of items that are subject to the campaign, as well as items that are outside of the campaign (representing an overall purchase basket of a given customer). Such interactions with a campaign may be provided as feedback and used as ingestion data for the campaign design subsystem 202 for subsequent campaigns.

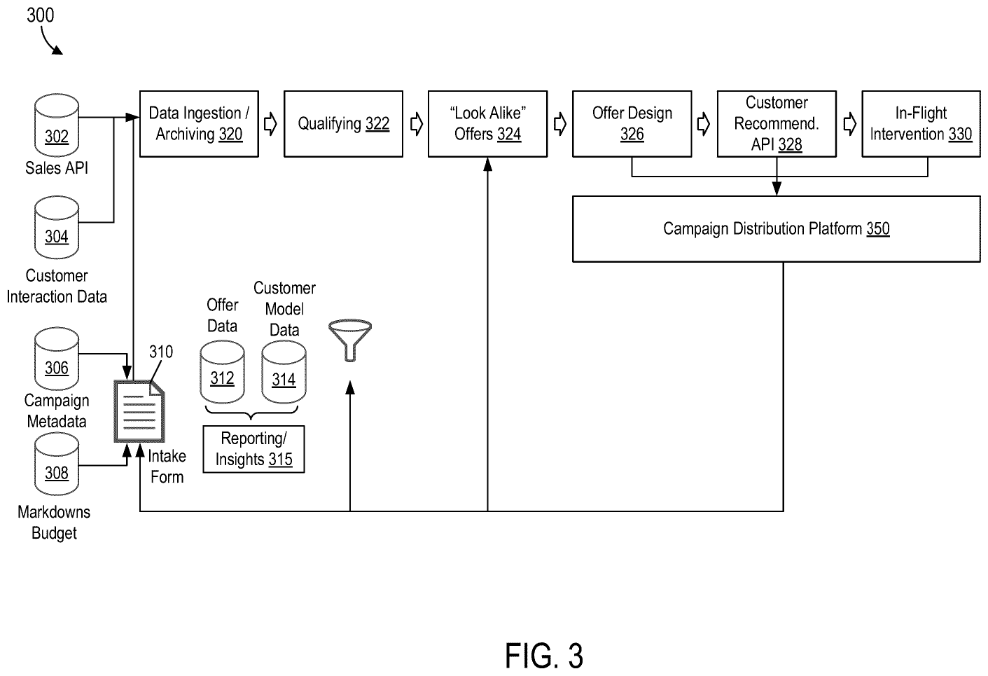

Referring now to FIG. 3, a schematic block diagram of an architecture of a campaign delivery system 300 is shown. The campaign delivery system is usable within the retail network of FIG. 1 to implement a campaign, for example as campaign delivery system 106.

In the example shown, the campaign delivery system 300 receives a variety of data for use in designing a given campaign. For example sales data associated with individual customers may be obtained via a sales API 302. Additionally, customer interaction data 304 may be ingested, and may include information about customers and their interactions with historical offers, as well as historical interaction information of the customer, such as online interaction history and the like. Additionally, a set of campaign metadata 306 may be received, as well as a markdown budget 308.

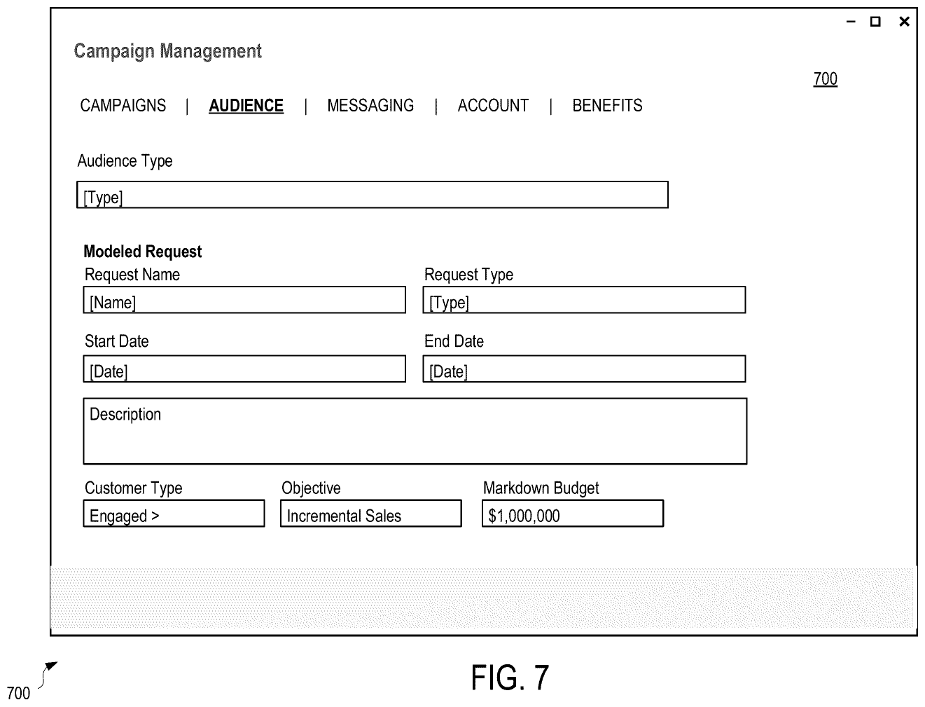

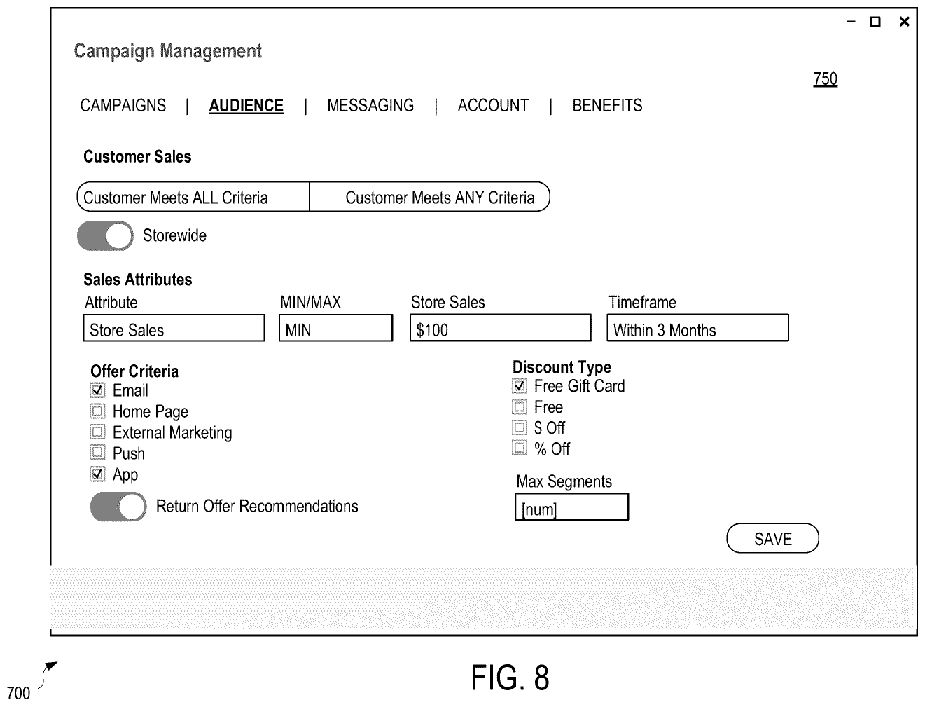

In the example shown, the campaign metadata 306 and markdown budget 308 may be received at an intake form 310, which may be a user interface generated by a campaign distribution platform 350. In example implementations, the campaign distribution platform may be implemented on a separate computing system from the other aspects of the system 300 of FIG. 3. Examples of such an intake form 310 are illustrated further below in conjunction with FIGS. 7-8. Campaign metadata received at such an intake form 310 may include, for example, an audience type, a campaign objective (e.g., incremental sales maximization, increased foot traffic, and the like), a duration of the campaign, and various customer selection criteria. Other information, such as a description of the particular campaign, a type of customer to be targeted (e.g. engaged, unengaged, and the like), and specific targeted attributes such as minimum or average basket size, offer types (email, homepage, external marketing, push message, and the like) and discount type (e.g., gift card, free item, or dollar or percentage off) may be included within such a definition as well. The user interface may also be used to define specific messaging to be included within a campaign, as is known in the art.

In the example shown, the campaign definition information obtained at the intake form 310, as well as the sales data received at sales API 302 and customer interaction data 304 may be received at a data ingestion subsystem 320, and stored in staging data tables of a database for analysis. Once ingested, a qualifying subsystem 322 may identify a plurality of users (e.g. customers) who may be candidates recipients for the defined campaign, based on user data available to the organization. The qualifying subsystem 322 may identify customers based on, for example, intended delivery mechanism and available data associated with that customer (e.g. if a mailing address is available for a customer, and direct mail is the intended delivery mechanism), whether the customer is potentially interested in the offer (e.g., has purchased items within a given category in a predetermined period of time), and the like. For example, a direct mail campaign promoting children's clothing may be best directed to customers who have purchased children's clothing in the last year, and for whom a mailing address is available. Other factors, such as geographic proximity, customer purchasing habits, and the like, may be used as well.

In the embodiment shown, a look-alike offer subsystem 324 identifies offers that are part of campaigns that are similar in attributes to the proposed campaign and related offers. In examples, a plurality of historical campaigns may be identified that are most similar to the current campaign. Based on this information, and the performance of those historical campaigns, a plurality of subsystems, including an offer design subsystem 326, a customer recommendation API 328, and an in-flight intervention subsystem 330 may operate to further define an audience and delivery strategy for a campaign, provide that campaign to the campaign distribution platform 350, and monitor the campaign to allow an administrative user (e.g., administrative user 108) to observe performance of the campaign during its duration.

Generally, the offer design subsystem 326 determines, based on the campaign, specific offers to be provided to specific customers or customer groups based on expected responsiveness to such offers. As discussed in further detail below, the offer design subsystem 326 may utilize past campaign performance, customer data including past purchases, and various other factors, such as seasonality, within one or more machine learning models usable to optimize customer-offer matches. The customer recommendation API 328 may transmit individualized offers as part of a campaign to the campaign distribution platform 350 for implementation, for example to generate direct mail offers, and/or to send messages to individual customers as part of that campaign. The in-flight intervention subsystem 330 allows administrative users, such as administrative user 108 described above, to adjust a campaign during its duration, for example to adjust delivery of campaign messages, such as offers, in response to observed performance of the campaign.

In addition, the defined campaign may result in definition of offer data 312, as well as a model of a customer or customers to receive the offer. A reporting and insights subsystem 315 may be used to filter and/or otherwise visualize performance of the campaign, to view the offers made within the context of a campaign, to view customer attributes for customers identified as being targeted by the campaign, and to illustrate prospective or actual performance of the campaign before and during its implementation.

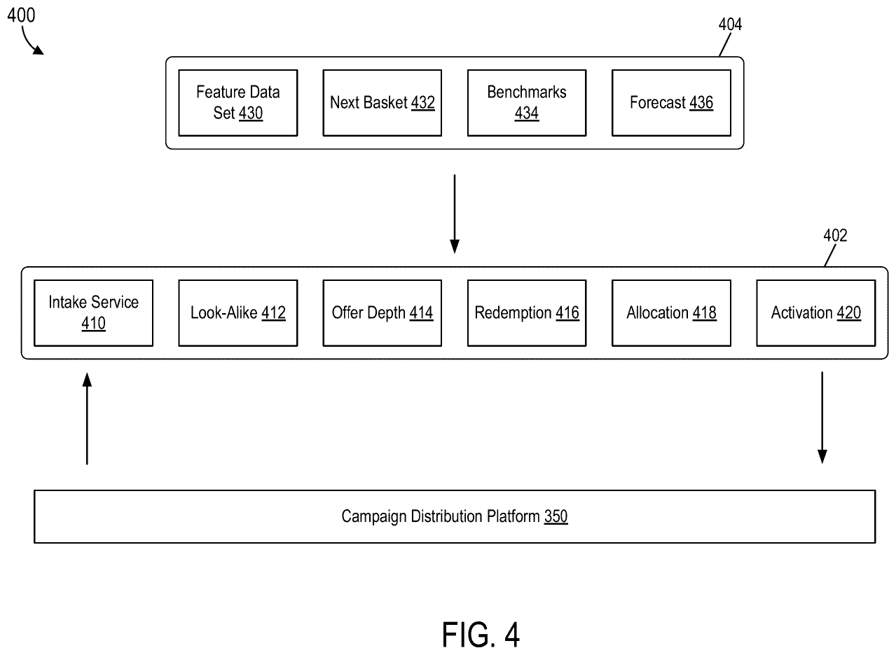

FIG. 4 is a schematic block diagram of an architecture of a campaign optimization tool 400 usable within the campaign delivery system of FIG. 3. The campaign optimization tool 400 may be utilized to implement one or more of the subsystems of the campaign delivery system 300 described above, including, for example, the subsystems 320-330 described above. In the example shown, the campaign optimization tool 400 includes a campaign optimization pipeline 402 and an offer data preparation subsystem 404, also referred to herein as a common offer preparation module.

Generally speaking, the campaign optimization pipeline 402 receives defined campaigns, including a variety of campaign attributes, and generates recommendations for detailed offers to be included within those campaigns based on an optimization analysis of the goals of the campaign, budget of the campaign, and customer data, among other factors. The offer data preparation subsystems 404 works in conjunction with the campaign optimization pipeline 402, but processes historical offer data, customer data, customer interaction data, and various other retail metrics, such as sales forecasting, to generate features usable within the campaign optimization pipeline 402. As illustrated, the campaign optimization pipeline 402 includes an intake service 410, a look-alike service 412, and offer depth service 414, a redemption service 416, and allocation service 418, and an activation service 420. Also, the offer data preparation subsystem 404 includes a feature data set module 430, a next basket module 432, a benchmarks module 434, and a forecast module 436.

In example embodiments, the intake service 410 receives a request for generation of an optimized campaign, for example from an API of a campaign distribution platform 350. The request may include a definition of a proposed or current campaign that includes a plurality of campaign parameters, including, for example, an audience type, a campaign objective, a duration of the campaign, a budget, and a set of customer selection criteria. Such campaign parameters may be received by the campaign distribution platform 350 either in part or in whole using a user interface as illustrated in FIGS. 7-8, below. The various campaign parameters may be stored in a database table of a database for subsequent analysis.

Generally speaking, the analysis provided by services 412-420 are supported by underlying data processing provided by the offer data preparation subsystem 404. In particular, the feature data set module 430 receives data, such as customer data, sales data, offer data associated with past campaigns, and the like, and generates values for a set of features that may be used in downstream models that are utilized to optimize the current campaign. The features assist with prediction of a particular customers next basket size (total value of goods purchased during a next shopping trip), whether customers will have a propensity to redeem a particular offer if presented, and a performance forecast of the offer overall, among other features.

Within the offer data preparation subsystem 404, the next basket module 432 is used to generate a prediction of a next basket size for a given customer. In example implementations, the next basket module 432 uses one or more machine learning models to predict the basket size for a particular customer based on prior purchasing behavior patterns, for example purchasing behavior patterns of that customer, as well as purchasing behavior patterns of customers who have redeemed similar offers. The one or more machine learning models may comprise convolutional or deep learning networks, or may correspond to a regression model trained on data at a category level for a given user. In example embodiments, more than one model may be used. In the examples described herein, the one or more models may generate a score representative of a basket size of a next purchase if an offer were to be redeemed. Such models may be trained or configured using the features extracted via the feature data set module 430. In particular, a convolutional or deep learning network may be trained using purchase histories of customers who have redeemed a particular offer, as well as customers potentially targeted by a particular campaign. Based on the offer or types of items included within an offer, and the types of items included within past purchase histories, a likely next basket size may be predicted, for example with a value and a confidence score.

The benchmarks module 434 includes one or more prediction models configured to generate predictions associated with a particular customer, including customer preference changes over time for a particular customer, and as a comparison to other customers. The benchmarks module 434 may generate one or more scores corresponding to benchmarks for a given customer within each of a plurality of categories over a past year of purchasing behavior. The customer purchasing habits within a given category, and association to the customer's overall basket of goods purchased, may be monitored and compared relative to other customers to determine relative value of offers made to individual customers over the course of a campaign.

The forecast module 436 generates one or more forecasts for campaign performance, including estimated redemption rates, estimated markdown costs, and estimated promotional sales, based on individual campaign inputs. In examples, the forecast module 436 uses historic offer and redemption data prior to selection of a particular audience for a campaign, based solely on historical campaign performance across various audiences, and similar campaigns. During an audience selection process, the forecast module 436 may interact with the look-alike service 412 to help find better look alike campaigns, and may interact with the redemption service 416 to better predict redemption rates of proposed audiences for a given campaign.

In a particular implementation, the forecast module 436 utilizes one or more statistical models derived from historic offer and redemption information associated with individual users, user groups, and campaigns. Accordingly, as other modules and services are used to optimize campaign performance, individual potential campaign designs or audience selections may be assessed by those modules and services using outputs from the forecast module 436. The historic offer and redemption data may be used, for example, from campaigns and offers occurring over the prior year for purposes of identifying matching performance and training a forecasting model.

In examples, the offer data preparation subsystems 404, and various modules therein, may be configured to analyze customer data on a regularized, periodic basis to ensure up to date model behavior. For example, the modules may be updated with newly ingested data on a daily or weekly basis. In further examples, data may be ingested on a more frequent basis, but individual models may be updated on an as needed basis or some other periodic basis.

Referring back to the campaign optimization pipeline 402, the look-alike service 412 performs an automated process to identify historic offers most similar to a proposed offer as received at the intake service 410. The look-alike service 412 may perform both a generation process and a selection process. The generation process may run periodically (e.g. weekly, biweekly, semiweekly, etc.) and generates a short list of a predetermined number of historic offers used as training data to be supplied to the feature data set module 430. The look-alike service 412 selects the short list of historic offers to maximize coverage of items purchased by potential customers. The short list may include 100 or more historic offers and associated sales performance statistics. The selection process may run on demand, and selects a small subset of look-alike offers to a current offer under consideration or current campaign under consideration. In examples, the selection process generates similarity scores between the short list of historic offers and the current offer based on defined characteristics of those offers, and selects a limited set of the historic offers having highest similarity scores. The similarity scores may be based, at least in part, on offer duration, category, discount extent, and seasonality, among other factors.

In example implementations, the look-alike service 412 uses a model that generates a set of embeddings based on offer details, wherein the embeddings define characteristics of the offer as described herein. The model used may be, for example, a neural network or other similar model capable of generating such and beddings in response to receipt of campaign or offer data. The look-alike service 412 may then analyze a distance between the embeddings of each of the historical offers and embeddings generated for the current offer, for example using a cosine distance or other similar distance metric between the embedding values of each historical offer and the current offer. In other examples, the look-alike service 412 may utilize a linear optimization to maximize coverage of items within a class of items to which the current campaign is directed, with the embeddings corresponding to optimization coefficients. The linear optimization may be performed, for example, using a weighted model scoring. In some implementations, the look-alike service 412 selects a top four look-alike offers with highest similarity scores; in other implementations, other numbers of offers having high similarity scores may be selected.

In the embodiment shown, an offer depth service 414 determines a set of one or more offers, and associated discounts, to be utilized within a particular campaign that is received as the current campaign. The offer depth service 414 may generate one or both of percentage and threshold offers based on similar campaigns from among the look-alike campaigns and their related performance. A percentage offer may correspond to a particular percentage discount to be applied to an item or group of items purchased within a classification of qualifying items, while a threshold offer may result in a monetary discount once a predetermined spending threshold has been reached, for example for a particular class of items or item, or for a basket that includes such an item or classification of items. The offer depth service may be implemented using one or more linear optimizations and/or heuristic models useable to select particular offers for inclusion within a given campaign.

In the example shown, a redemption service 416 implements a classification model that uses historic customer data to predict a likelihood of a particular customer, or customer group, redeeming a particular offer to be included within a campaign. The redemption service may, in some example embodiments, use machine learning models that are configured using the training data and features provided by the feature data set module 430, and may generate redemption likelihood scores for individuals or groups within a universe of potential marketable customers. By aggregating and analyzing the redemption likelihood scores of each customer or group, cross-referencing by customer/group attribute allows for optimization of a budget set for an overall campaign by selecting particular customer groups having a highest propensity to respond to a particular offer, determine an expected redemption amount, and thereby generate a strategy for distribution of that campaign.

In the example shown, the allocation service 418 obtains a list of potential customers, or customer groups, to whom an offer may be allocated based on prior sales and customer criteria, as well as redemption scores for the particular offer as generated by the redemption service. The allocation service 418 executes a plurality of scenarios in which customer offers are mapped to given campaign objectives. By performing a multivariate optimization process, using redemption likelihood scores and a next basket size for a given customer as optimization parameters, a customer-offer pairing may be made, in which a particular offer is associated with a customer or group of customers based on the redemption scores associated with that customer or group. In the example shown, the allocation service 418 generates a mapped list of customer-offer groups, for example using a linear optimization function constrained by the user-defined budget included in the plurality of campaign parameters received by the campaign optimization tool 400.

In the example shown, an activation service 420 creates a test list and a control list using a plurality of variables with stratified sampling. In the example, the activation service 420 creates and validates a particular audience list for an offer, as well as metadata defining the audience and offer to which the audience is to be associated. The activation service 420 can then separate the audience list into test and control lists that are statistically similar to each other, and may publish the audience metadata defining customer groups and associated offers, as well as groups to which those customers are associated, to the campaign distribution platform 350. The campaign distribution platform 350 may then activate the campaign by distributing the offers to customer groups, for example by assigning offers to the test customer group or by assigning/delivering offers to the individuals within a complete list of customer-offer pairings.

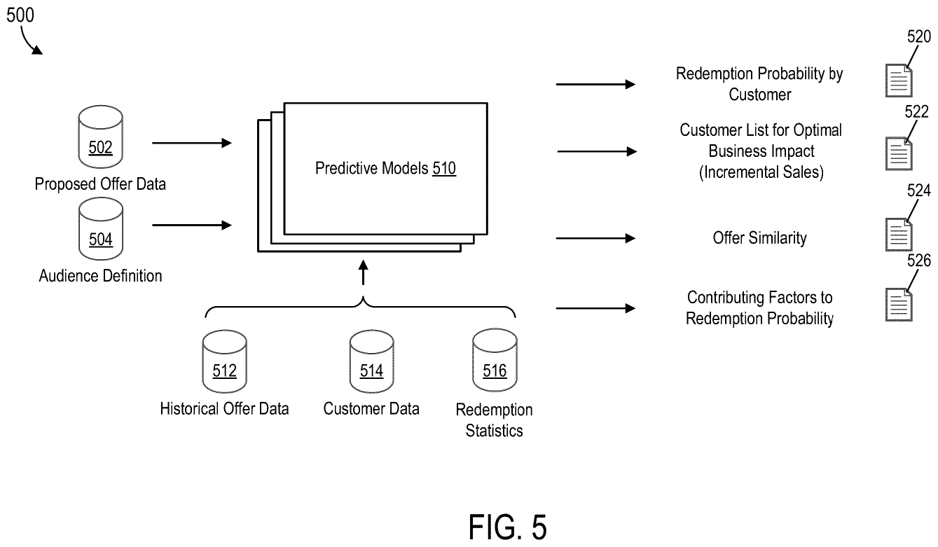

Referring to FIG. 5, an example model repository 500 may be provided, and may be used to implement one or both of the campaign optimization pipeline 402 and the offer data preparation subsystem 404. In the example shown, the model repository 500 receives proposed offer data 502 and audience definition data 504, and provides that information to one or more predictive models 510 to generate various outputs. The predictive models 510 may be trained using one or more of historical data 512, customer data 514, and redemption information 516, to perform the functions described above, including, for example: identifying similar offers (e.g., offer similarity data 524), analyzing a likelihood of redemption of a given offer by a customer or customer group (e.g., redemption probability data 520), or generating customer-offer lists of ranked customers or customer groups by propensity to redeem a given offer (e.g., customer list data 522). In example implementations, the one or more predictive models 510 may be implemented as different types of models depending on the function performed, such as neural networks, decision trees, and the like. In example implementations, modules of the offer data preparation subsystems 404 may generate features and/or train models for use, and the campaign optimization pipeline 402 may call or utilize one or more trained models to optimize a campaign within received campaign parameters. In examples, where a neural network is used as one of the predictive models 510 for determining redemption probabilities, the model may be constructed as a function-behavior-structure model configured to predict behavior based on a function and structure.

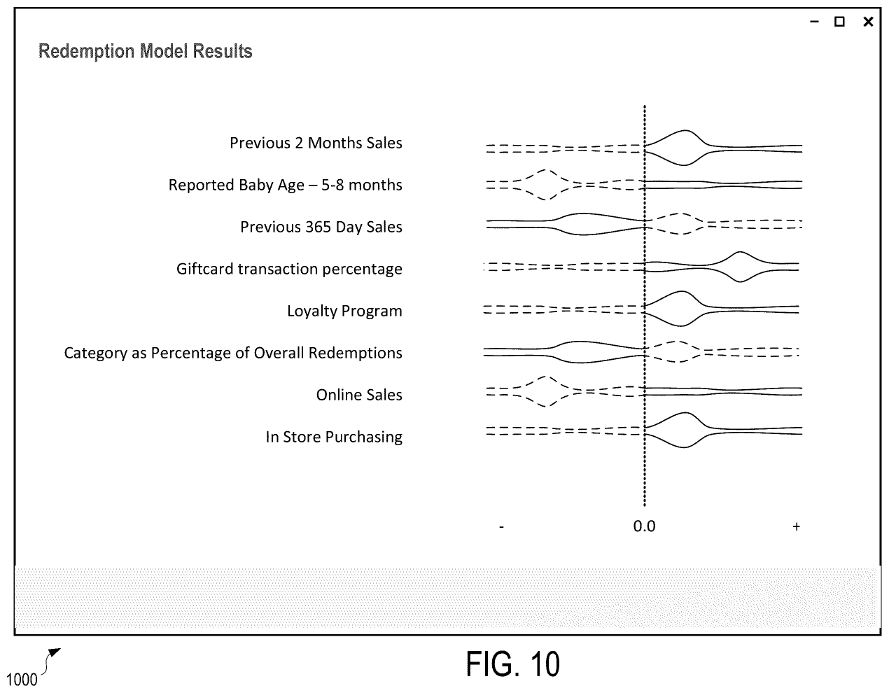

In the example shown, the model repository 500 may also expose, from the predictive models 510, particular factors 526 contributing to a given score or classification. For example, a campaign offering incentives for purchase of babies supplies may have a plurality of features, including, e.g., whether customers had purchased baby supplies in the last two months, age of the baby as reported into a baby registry, total sales to the customer in the prior year, whether the customer is a loyalty customer, presentation of offers in Baby category in combination with other offers or exclusively within the baby category, store distance, and the like. Such features may be specific to a model tuned for use with a campaign to sell baby supplies, but similar features may be used in other categories. In this instance, it may be observable that customers who had purchased baby items in the previous two months have a higher propensity to redeem an offer is presented, or that customers having babies reported as being at least seven months old have a higher propensity to redeem offers as compared to customers with babies having a reported age of five months or less. Additionally, customers who make purchases in-store may be more likely to redeem offers than those who conduct more shopping online. Such factors may be ordered and displayed to an administrative user following training and execution of one or more of the models described herein, for example using an interface such as the one discussed below in conjunction with FIG. 10.

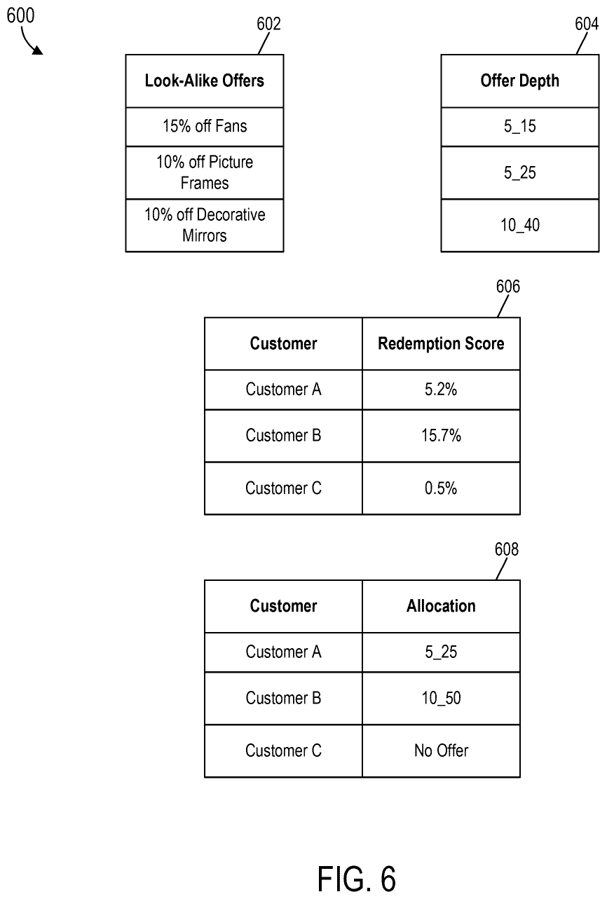

FIG. 6 is an example data set 600 usable to generate recommended campaigns using the campaign optimization tool described herein. The example data set 600 represents data generated using the campaign optimization pipeline 402 in example embodiments. As illustrated, the example data set 600 includes a plurality of look-alike offers 602, and offer depth listing 604, a redemption likelihood score for a plurality of users or user groups 606, and an allocation list tying customers or customer groups to specific offer types 608.

For example, the plurality of look-alike offers 602 may correspond to specific offers made in a same category and with a same discount level as the currently proposed offer. In this example, a housewares offer may result in identification of a set of offers including 15% off fans, 10% off picture frames, and 10% off decorative mirrors. Such look-alike offers 602 may be generated, for example, using the look-alike service 412 described above. The offer depth listing 604 may generate a plurality of offer depths, e.g., percentages or dollar values of discount to be offered. In the example shown, a first offer depth may be selected at five to 15%, a second offer depth may be selected at five to 25%, and a third offer depth may be selected at 10 to 40% discount. Offer depths may be generated via the offer depth service 414 described above.

In the example shown, redemption scores may be generated by a redemption service or 16, and may correspond to percentage likelihood of redemption by individual customers or customer groups. In the example shown, Customer A may have a redemption score of 5.2%, Customer B may have a redemption score of 15.7%, and Customer C may have a redemption score of 0.5%. Such scores may be generated for an individual offer, and may be generated for each offer for which the customer is considered a potential candidate recipient.

In the example shown, the allocation list 608 tying customers or customer groups to specific offer types represents a final list of customer-offer pairings that may be used, in whole or in part, within the campaign as defined. The allocation list may be, in some instances, separated into test and control lists as well, with some of the group presented with the offer and others within the group not presented with the offer to analyze sales lift for that group during the course of the campaign. Such an arrangement may be particularly advantageous in a situation where it is desirable to analyze the impact on incremental sales of the selection and optimization of audience to offer optimization provided by the campaign optimization tool 400.

In some examples, using the models as described above in conjunction with FIGS. 4-5, specific factors contributing to identification of particular customers or customer groups as optimal or matched in customer-offer pairs may be generated. Such contributions may indicate sensitivity to a particular feature of a model that has a greatest contribution to a redemption score or identification of a customer group. Such factors may be identified as outputs to the campaign distribution platform 350, and optionally displayed in a user interface depicting campaign redemption rate information or campaign information, as further discussed below.

Referring to FIGS. 7-10, example user interfaces that may be presented by either a campaign optimization tool 400 or a campaign distribution platform 350 are provided. In a particular embodiment, the user interfaces may be generated and presented by a campaign distribution platform 350 and accessible to campaign administrative users to define campaign parameters, as well as view campaign generation and performance in accordance with the selection of customer-offer pairs provided by the campaign optimization tool 400.

Referring first to FIG. 7, a campaign management user interface 700 includes a plurality of tabs, including a campaigns tab, and audience tab, a messaging tab, and account tab, and a benefits tab. In the example shown, the audience tab is active. Within the campaign management user interface 700, a campaign may be defined, followed by definition of parameters associated with a desirable audience in the audience tab. As illustrated, an audience type may be selected. The audience type may be selected from among particular past customer groups, such as customers within a particular geographic area, customers who have purchased within the last 30 days, customers who have purchased items online or in-store, and the like. The audience tab may also include a series of fields associated with a modeled request. For example, a user may be able to define a request name, a request type, a start and end date, and a description of a campaign to be defined. Additionally, for the campaign, a customer type (e.g., engaged, passive, etc.), and objective (e.g., incremental sales, new customer engagement, encouraging in-store shopping trips, revenue maximization, and the like), and an overall markdown budget (in projected dollars spent) may be defined.

FIG. 8 illustrates a further view 750 of a user interface, which may be included within the same screen or a different screen as the campaign management user interface 700 of FIG. 7. In this example, additional parameters may be defined around the customer to be associated with a given campaign. For example, a user may define specific criteria associated with a customer, such as a particular attribute of the customer (in the example shown, that the customer purchased items in store), a minimum or maximum dollar value for the purchase associated with the customer (in this example, a minimum $100 purchase at the store), and a particular timeframe (e.g., within the last three months). Each of these attributes is configurable to assist in definition of a desired customer group to be assessed for inclusion within a campaign.

Additionally, one or more offer criteria or offer types may be defined. Offer criteria may include a communication channel by which the offer is distributed (e.g., email, website homepage, external marketing, SMS/MMS push message, or application push message). Offer types may include a percentage discount, a constant value (e.g., dollars) discount, a gift card reward, or a free item in response to redemption of a particular offer.

In the example shown, the saved campaign parameters and customer parameters received at user interfaces 700, 750 may be provided from the campaign distribution platform 350 to the campaign optimization tool 400 to generate detailed optimizations regarding specific customer-offer pairs based on similar campaigns (look-alikes), offer depth distribution analysis, offer to audience analysis, and optimization of goals as defined for the campaign. Such customer-offer pairs may be returned to the campaign distribution platform 350, either as a definition of a campaign or separated into tests and control lists for use in a campaign. Such test and control lists may be distributed and analyzed, in particular in accordance with digital distribution channels, using techniques for omnivariate testing as described in U.S. patent application Ser. No. 16/516,877, the disclosure of which is hereby incorporated by reference in its entirety.

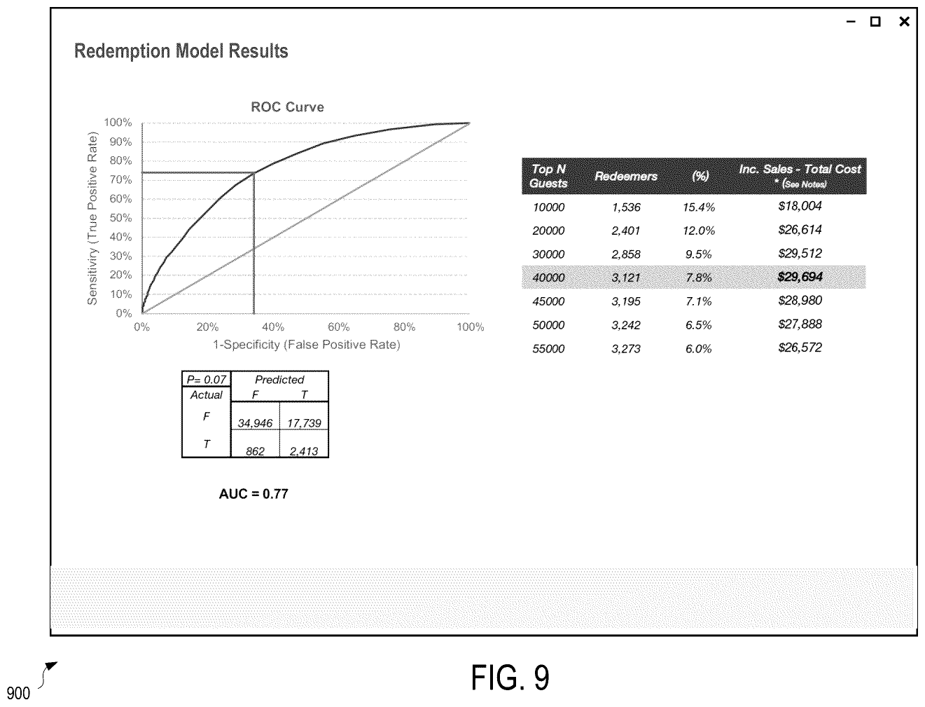

FIGS. 9-10 illustrate further user interfaces that may present graphical depictions of characteristics of campaigns prior to, during, and after campaign execution. FIG. 9 is a schematic diagram of a campaign performance user interface 900 illustrating redemption results in an example application of a campaign according to an example embodiment. In this example, the user interface presents results of a redemption model for a proposed campaign, illustrating a sensitivity to the optimized set of customer-offer groups, and indicating an overall improvement in incremental sales based on a projected redemption rate and number of customers to whom the offer will be presented. As illustrated, a maximum incremental sales gain can be identified when sending offers to a top 40,000 customers, with 3,121 redeemers expected and a peaking value for incremental sales minus total cost (where cost correlates to a cost of campaign distribution). In addition, other types of calculations may be performed and metrics displayed, for example to assess precision-recall and/or reliability of models used.

FIG. 10 is a schematic diagram of a further campaign performance user interface 1000 illustrating redemption results in an example application of a campaign according to an example embodiment. In this example, an example campaign for baby products is analyzed, and factors, or features, both positively and negatively correlated with campaign performance and selection of particular audiences are illustrated. In the example shown, solid lines reflect positive correlation, while dashed lines correlate to negative correlation. As seen, a user interface may display a positive correlation between, for example, gift card redemption percentage and offer redemption, or a propensity to shop in store with redemption likelihood. A negative correlation may be determined between online sales and redemption, or having a baby of ages 5-8 months (as might have been reported in a baby registry associated with the customer). Other correlations may be determined from the modeling described herein, and displayed to a user associated with the enterprise, for example at administrative user device 108 of FIG. 1.

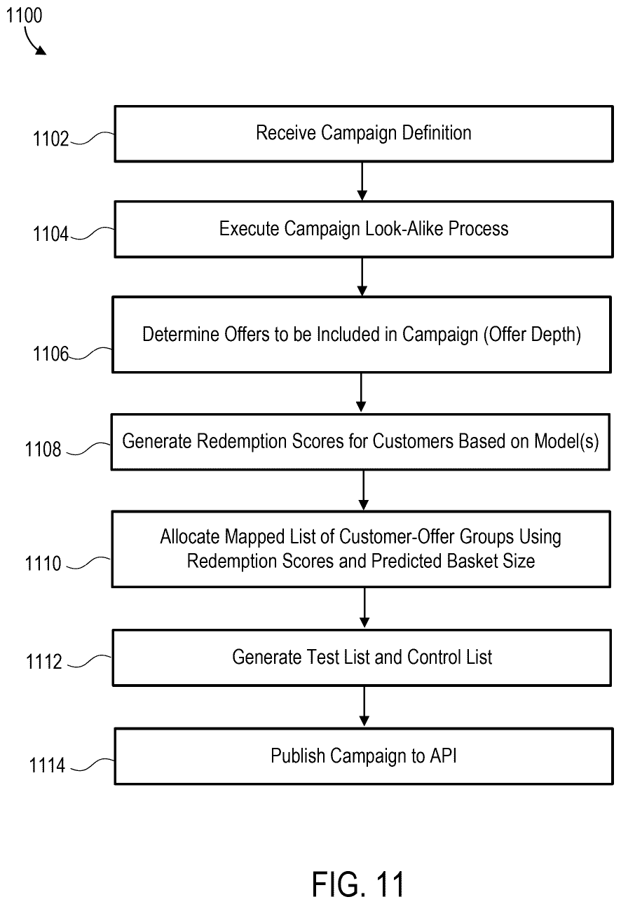

FIG. 11 is a flowchart of an example method 1100 of generating a campaign using the campaign distribution system and campaign optimization tool as described herein. The method 1100 may be performed, for example in whole or in part, by the campaign optimization tool and campaign distribution systems described herein.

In the example embodiment shown, the method 1100 includes receiving a definition of a campaign (step 1102). Receiving the definition of the campaign may be performed, for example, using a user interface exposed by a campaign distribution system, which receives campaign parameters. The campaign parameters may include, for example, an audience type, a campaign objective, a duration of the campaign, a budget, and a set of customer selection criteria. Other campaign definition criteria may be provided as well via the user interface, received by the campaign distribution system, and provided to a campaign optimization tool for ingestion. Receiving the definition of the campaign, from the perspective of the campaign optimization tool, can include ingesting the campaign definition at an intake service module, and storing the campaign definition in a database table for use in downstream optimization processes.

In the example embodiment shown, the method 1100 further includes executing a look-alike process to identify historical campaigns having similarity to the campaign definition (step 1104). The look-alike process may include identifying one or more historical campaigns having a similarity score indicating a greatest similarity to the campaign as defined and received at the campaign optimization tool. The look-alike process may include generating similarity scores for each of a plurality of historical campaigns, and selecting a predefined number of campaigns, or up to a predefined number of campaigns that exceed a threshold similarity score. In some examples, up to four historical campaigns may be selected.

In the example embodiment shown, the method 1100 includes determining one or more offers to be included in the campaign (step 1106). Determining the offers to be included in the campaign can include determining offers at a variety of offer depths (e.g. an extent of discount), based on performance of historical campaigns having the greatest similarity to the campaign definition. The offer depths may be a percentage discount, a dollars discount (e.g. at a particular price threshold, a predefined value discount), or other types of discounts or purchasing incentives. The offer depths may be defined and analyzed at a variety of levels. For example, in the case of a percentage discount, similar campaigns having offers at different discount levels may be analyzed to determine performance (e.g., sales performance or overall basket size performance in response to a 10% discount, a 20% discount and the like).

In the example embodiment shown, the method 1100 includes generating redemption scores for a plurality of customers or customer groups (step 1108). The redemption scores may be representative of a likelihood of a customer redeeming the one or more offers that may be included within the campaign. The redemption score may be generated by a model of customer behavior, and may be performed on models associated with individual customers, or customer groups sharing a common characteristic (e.g., having shopped in a particular category recently, being a loyalty shopper, and the like). The method 1100 may also include, based on the redemption scores, allocating to a campaign a mapped list of customer-offer groups (step 1110). The mapped list of customer-offer groups may include pairs of customer groups with offers that are generated at one or more offer depths, based, at least in part, on redemption scores of the customers and/or customer groups as associated with the individual offers at the varying offer depths. The mapped list may be based on a top number of customer-offer groups and expected redemption rates that may meet an overall campaign budget, and may be a subset of the overall set of pairs of customer-offer groups that are assessed. Additionally, the mapped list may be ordered, or weighted, based further on an expected basket size for each customer in the event of redemption of the offer. The expected basket size may be derived, for example, from the next basket module 432. In particular, a score generated by the next basket module 432 may be used to further weight the redemption scores within the mapped list.

In the example embodiment shown, the method 1100 includes, optionally, generating a test list and a control list of the customer-offer groups (step 1112). For example, each customer-offer group may be separated at the customer level, such that a subset of customers will be included within the test list and the control list and each individual offer within the campaign may be assessed. This may be utilized, for example, in situations where made to campaign performance assessment is desired (e.g., to determine exact sales lift of a particular campaign or offer). The method 1100 also includes, in the example shown, publishing the optimized campaign to an API (step 1114). The API may be a campaign API managed by a campaign distribution platform.

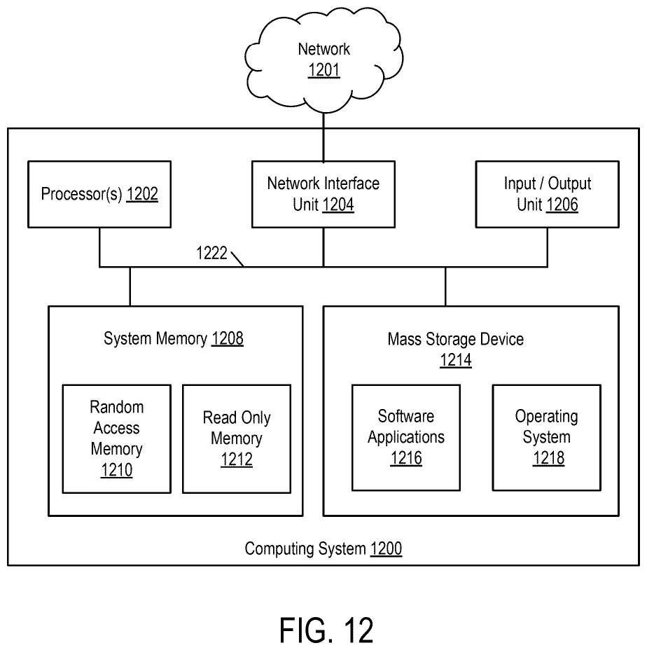

FIG. 12 illustrates an example block diagram of a virtual or physical computing system 1200. One or more aspects of the computing system 1200 can be used to implement the campaign delivery system 106 or other computing systems described above in conjunction with FIG. 1, for example the campaign optimization tool 400 and/or the campaign distribution platform 350 of FIGS. 3-4.

In the embodiment shown, the computing system 1300 includes one or more processors 1202, a system memory 1208, and a system bus 1222 that couples the system memory 1208 to the one or more processors 1202. The system memory 1208 includes RAM (Random Access Memory) 1210 and ROM (Read-Only Memory) 1212. A basic input/output system that contains the basic routines that help to transfer information between elements within the computing system 1200, such as during startup, is stored in the ROM 1212. The computing system 1200 further includes a mass storage device 1214. The mass storage device 1214 is able to store software instructions and data. The one or more processors 1202 can be one or more central processing units or other processors.

The mass storage device 1214 is connected to the one or more processors 1202 through a mass storage controller (not shown) connected to the system bus 1222. The mass storage device 1214 and its associated computer-readable data storage media provide non-volatile, non-transitory storage for the computing system 1200. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, DVD (Digital Versatile Discs), other optical storage media, magnetic cassettes, magnetic tape, magnetic disk storage or other magnetic storage devices, or any other medium which can be used to store the desired information and which can be accessed by the computing system 1200.

According to various embodiments of the invention, the computing system 1200 may operate in a networked environment using logical connections to remote network devices through the network 1201. The network 1201 is a computer network, such as an enterprise intranet and/or the Internet. The network 1201 can include a LAN, a Wide Area Network (WAN), the Internet, wireless transmission mediums, wired transmission mediums, other networks, and combinations thereof. The computing system 1200 may connect to the network 1201 through a network interface unit 1204 connected to the system bus 1222. It should be appreciated that the network interface unit 1204 may also be utilized to connect to other types of networks and remote computing systems. The computing system 1200 also includes an input/output controller 1206 for receiving and processing input from a number of other devices, including a touch user interface display screen, or another type of input device. Similarly, the input/output controller 1206 may provide output to a touch user interface display screen or other type of output device.

As mentioned briefly above, the mass storage device 1214 and the RAM 1210 of the computing system 1200 can store software instructions and data. The software instructions include an operating system 1218 suitable for controlling the operation of the computing system 1200. The mass storage device 1214 and/or the RAM 1210 also store software instructions, that when executed by the one or more processors 1202, cause one or more of the systems, devices, or components described herein to provide functionality described herein, including one or more software applications 1216. For example, the mass storage device 1214 and/or the RAM 1210 can store software instructions that, when executed by the one or more processors 1202, cause the computing system 1200 to receive and execute instructions for optimizing and delivering campaign communications among identified audiences.

Referring to FIGS. 1-12 generally, the optimization tools and user interfaces described herein provide a number of advantages relative to existing systems. For example, while in existing systems a user may be able to manually identify an audience of intended recipients for a given offer, it would be difficult to properly subdivide the audience to identify individuals who are most likely to redeem the offer, and in particular those individuals most likely to redeem the offer in conjunction with a cart or basket size (total purchase size) that increases or improves upon incremental revenue to a maximum extent possible. Use of a series of machine learning models, each trained periodically using customer, historical offer, and sales data, and comparison of current proposed campaign information to past offers to generate customer offer pairs, not only automates this audience identification process, it maximizes the likelihood of success of a given campaign. Furthermore, automatically subdividing the audience into test and control groups allows for assessment of effectiveness of a given campaign, which may be conveniently deployed and monitored. Other advantages are provided as well, in conjunction with the above description and following claims.

The above specification, examples and data provide a complete description of the manufacture and use of the composition of the invention. Since many embodiments of the invention can be made without departing from the spirit and scope of the invention, the invention resides in the claims hereinafter appended.

Although the present disclosure and the advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A method of optimizing an information distribution campaign for delivery to an audience, the method comprising:
receiving, at a campaign definition user interface of a campaign distribution platform, a campaign definition of a current campaign including a plurality of campaign parameters, the plurality of campaign parameters including an audience type, a campaign objective, a duration of the campaign, a budget, a set of customer selection criteria;
intaking the campaign definition at an intake service module and storing the campaign definition in a database table;
automatically executing a lookalike process to identify historical campaigns having a greatest similarity to the campaign definition, the lookalike process generating a similarity score for each of a plurality of the historical campaigns;
determining one or more offers to be included in the campaign based, at least in part, on performance of the historical campaigns having the greatest similarity to the campaign definition, the one or more offers including at least one percentage offer or at least one threshold offer;
generating, at a model trained using historical customer and campaign data, a redemption score representative of a likelihood of a customer redeeming each of the one or more offers, the redemption score being generated by the model for each of a plurality of customer-offer groups across a plurality of customers;
allocating to a campaign a mapped list of customer-offer groups from among the plurality of customer-offer groups based on at least one of the redemption scores or a predicted basket size of each customer in the customer-offer groups;
generating a test list and a control list of customers from among the customer-offer groups; and
publishing the current campaign to a campaign API managed by the campaign distribution platform.

2. The method of claim 1, wherein the campaign parameters further include a discount type and one or more offer criteria.

3. The method of claim 2, wherein the similarity score is based on one or more of the duration of the campaign, a category of offer, the discount type, and one or more seasonality factors.

4. The method of claim 1, further comprising displaying, on an administrative user interface, one or more analytics regarding performance of the campaign by displaying performance of the test list relative to the control list.

5. The method of claim 1, further comprising displaying, on the administrative user interface, one or more contributing factors identified in the model as contributing to a redemption performance of the campaign.

6. The method of claim 1, wherein the model comprises a neural network based model constructed as a function-behavior-structure model configured to predict behavior based on a function and structure.

7. The method of claim 6, wherein the model is trained using customer information, redemption information, and campaign information from historical campaigns.

8. The method of claim 1, wherein the lookalike process uses a linear optimization to maximize coverage of items within a class of items to which the current campaign is directed, the linear optimization being performed using a weighted model scoring.

9. The method of claim 1, wherein the predicted basket size is derived from a basket size prediction model.

10. The method of claim 1, wherein the historical customer and campaign data is selected from among the historical campaigns having the greatest similarity to the campaign definition.

11. The method of claim 1, wherein the mapped list of customer-offer groups is generated using a linear optimization function constrained by the budget included in the plurality of campaign parameters.

12. A campaign definition and optimization system comprising:
a campaign distribution platform operable on a computing system, the campaign distribution platform exposing a campaign definition user interface and a campaign API;
a campaign optimization tool executable on a second computing system, the campaign optimization tool being executable by a processor of the second computing system to perform:
receiving, from the campaign distribution platform via the campaign API, a campaign definition of a current campaign including a plurality of campaign parameters, the plurality of campaign parameters including an audience type, a campaign objective, a duration of the campaign, a budget, a set of customer selection criteria;
intaking campaign definition at an intake service module and storing the campaign definition in a database table;
automatically executing a lookalike process to identify historical campaigns having a greatest similarity to the campaign definition, the lookalike process generating a similarity score for each of a plurality of the historical campaigns;
determining one or more offers to be included in the campaign based, at least in part, on performance of the historical campaigns having the greatest similarity to the campaign definition, the one or more offers including at least one percentage offer or at least one threshold offer;
generating, at a model trained using historical customer and campaign data, a redemption score representative of a likelihood of a customer redeeming each of the one or more offers, the redemption score being generated by the model for each of a plurality of customer-offer groups across a plurality of customers;
allocating to a campaign a mapped list of customer-offer groups from among the plurality of customer-offer groups based on at least one of the redemption scores or a predicted basket size of each customer in the customer-offer groups;
generating a test list and a control list of customers from among the customer-offer groups; and
publishing the current campaign to the campaign API managed by the campaign distribution platform.

13. The campaign definition and optimization system of claim 12, wherein the campaign distribution platform and the campaign optimization tool are associated with a retail organization, and wherein the campaign includes at least one offer designated for physical mail distribution.

14. The campaign definition and optimization system of claim 12, wherein the lookalike process uses a linear optimization to maximize coverage of items within a class of items to which the current campaign is directed, the linear optimization being performed using a weighted model scoring.

15. The campaign definition and optimization system of claim 14, wherein the historical customer-campaign interaction data is selected from among the historical campaigns having the greatest similarity to the campaign definition.

16. The campaign definition and optimization system of claim 15, wherein the mapped list of customer-offer groups is generated using a linear optimization function constrained by the budget included in the plurality of campaign parameters.

17. The campaign definition and optimization system of claim 16, wherein the model comprises a neural network based model constructed as a function-behavior-structure model configured to predict behavior based on a function and structure.

18. The campaign definition and optimization system of claim 12, further comprising a plurality of models, and wherein the model is selected from among the plurality of models based on predictive performance associated with similar campaigns.

19. The campaign definition and optimization system of claim 12, wherein the campaign optimization tool includes a common offer preparation module used to generate a plurality of campaign features.

20. A computer-readable medium storing computer-executable instructions which, when executed by a processor of a computing system, cause the computing system to perform a method of optimizing an information distribution campaign for delivery to an audience, the method comprising:
receiving, at a campaign definition user interface of a campaign distribution platform, a campaign definition of a current campaign including a plurality of campaign parameters, the plurality of campaign parameters including an audience type, a campaign objective, a duration of the campaign, a budget, a set of customer selection criteria;
intaking the campaign definition at an intake service module and storing the campaign definition in a database table;
automatically executing a lookalike process to identify historical campaigns having a greatest similarity to the campaign definition, the lookalike process generating a similarity score for each of a plurality of the historical campaigns;
determining one or more offers to be included in the campaign based, at least in part, on performance of the historical campaigns having the greatest similarity to the campaign definition, the one or more offers including at least one percentage offer or at least one threshold offer;
generating, at a model trained using historical customer and campaign data, a redemption score representative of a likelihood of a customer redeeming each of the one or more offers, the redemption score being generated by the model for each of a plurality of customer-offer groups across a plurality of customers;
allocating to a campaign a mapped list of customer-offer groups from among the plurality of customer-offer groups based on at least one of the redemption scores or a predicted basket size of each customer in the customer-offer groups;
generating a test list and a control list of customers from among the customer-offer groups; and
publishing the current campaign to an API managed by the campaign distribution platform.
